(19) United States
(12) Patent Application Publication
(10) Pub. No.: US 2010/0110213 A1
(43) Pub. Date: May 6, 2010

(54) IMAGE PROCESSING PROCESSOR, IMAGE PROCESSING METHOD, AND IMAGING APPARATUS

(75) Inventors: Katsuyuki KIMURA, Kanagawa (JP); Takashi MIYAMORI, Kanagawa (JP); Shunichi ISHIWATA, Chiba (JP); Takahisa WADA, Kanagawa (JP); Keiri NAKANISHI, Kanagawa (JP); Masato SUMIYOSHI, Tokyo (JP); Yasuki TANABE, Tokyo (JP); Ryuji HADA, Kanagawa (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KABUSHIKI KAISHA TOSHIBA, Tokyo (JP)

(21) Appl. No.: 12/552,680

(22) Filed: Sep. 2, 2009

(30) Foreign Application Priority Data
Oct. 30, 2008 (JP) 2008-280180

(51) Int. Cl. H04N 5/225; G06T 1/00

(52) U.S. Cl. 348/222.1; 345/522; 348/E05.024

(57) ABSTRACT

An input unit that sequentially writes a digital image signal to be input in a first buffer while counting number of pixels of the digital image signal, and that writes the written digital image signal in a second buffer; and a command fetching/issuing unit that calculates a position of a pixel based on process delay information that is added to an image processing command and that indicates a delay amount required until image processing by the command is started since the input of the digital image signal, and a counter value indicating the number of pixels, and that issues the image processing command when the position of the pixel is in a valid area are included. Image processing is performed on pixels written in the second buffer based on the issued image processing command.

### CROSS-REFERENCE TO RELATED APPLICATIONS

This application is based upon and claims the benefit of priority from the prior Japanese Patent Application No. 2008-280180, filed on Oct. 30, 2008; the entire contents of which are incorporated herein by reference.

### BACKGROUND OF THE INVENTION

1. Field of the Invention

The present invention relates to an image processing processor, an image processing method, and an imaging apparatus.

2. Description of the Related Art

Conventionally, an image processing processor that is mounted on an imaging apparatus such as a video camera and a digital still camera, and that performs image processing on image data that is output from a complementary metal oxide semiconductor (CMOS) sensor and the like has a configuration in which a buffer to temporarily store image data is used to perform image processing sequentially on image data in a raster-scanned order that is successively input at a fixed data rate, to perform pipeline processing.

Meanwhile, for such an image processing processor, there has been a demand for reduction in the area of an image processing processor by decreasing the capacity of a buffer, because there is severe limitation in a physical area generally. To respond to this demand, it can be considered that synchronization points are increased (shorten a synchronization cycle) to decrease the size of image data that is handled at a single synchronization operation, so that the capacity of the buffer can be reduced.

Japanese Patent Application Laid-Open No. 2003-29979 discloses a technique of reducing the size of communicated image data to a size equal to or smaller than the number of pixels of one line with such a configuration that synchronization is performed when received image data reaches a predetermined data amount. However, although the technique enables reduction of the capacity of an input buffer in which image data that is input from an external device is temporarily stored and the capacity of an output buffer in which image data that is to be output to an external device is temporarily stored, an intermediate buffer requires the capacity at least sufficient for a line or a frame because the intermediate buffer in which a processor core temporarily stores intermediate data is configured to store image data such that a position of a pixel can be controlled by a memory address. Therefore, the reduction of the capacity of a buffer has been limited.

### BRIEF SUMMARY OF THE INVENTION

An image processing processor according to an embodiment of the present invention comprises:

an input unit that sequentially writes a digital image signal to be input in a first buffer while counting number of pixels of the digital image signal, and that reads the digital image signal written in the first buffer to write in a second buffer;

a command storage unit that stores an image processing command to which process delay information is added, the process delay information indicating a delay amount required until image processing is started by the image processing command since input of the digital image signal to the input unit;

a command fetching/issuing unit that fetches the image processing command from the command storage unit, that calculates a position of a pixel targeted for the image processing by the fetched image processing command in an image frame of a digital image signal based on the process delay information added to the fetched image processing command and a counter value indicating the number of pixels obtained by the input unit, and that issues the fetched image processing command when a calculated position is in a valid area, and does not issue the fetched image processing command when the calculated position is not in the valid area; and

a command executing unit that performs image processing on the pixel targeted for the image processing written in the second buffer by executing the image processing command issued by the command fetching/issuing unit.

An image processing method according to an embodiment of the present invention comprises:

writing a digital image signal to be input sequentially in a first buffer while counting number of pixels of the digital image signal, and reading the digital image signal written in the first buffer to write in a second buffer;

fetching an image processing command to which process delay information is added from a command storage unit, the process delay information indicating a delay amount required until image processing is started by the image processing command since input of the digital image signal;

calculating a position of a pixel targeted for the image processing by the fetched image processing command in an image frame of a digital image signal based on the process delay information added to the fetched image processing command and a counter value indicating the number of pixels;

issuing the fetched image processing command when a calculated position is in a valid area, and arranging not to issue the fetched image processing command when the calculated position is not in the valid area; and

performing the image processing on the pixel targeted for the image processing written in the second buffer by executing the issued image processing command.

An imaging apparatus according to an embodiment of the present invention comprises:

a digital-image-signal generating unit that outputs a digital image signal at a fixed data rate from an optical image of a subject; and

an image processing processor to which a digital image signal generated by the digital-image-signal generating unit is sequentially input, and that sequentially performs image processing on the digital image signal, in synchronization with the input, wherein

the image processing processor comprises:

an input unit that sequentially writes a digital image signal to be input in a first buffer while counting number of pixels of the digital image signal, and that reads the digital image signal written in the first buffer to write in a second buffer;

a command storage unit that stores an image processing command to which process delay information is added, the process delay information indicating a delay amount required until image processing is started by the image processing command since input of the digital image signal to the input unit;

a command fetching/issuing unit that fetches the image processing command from the command storage unit, that calculates a position of a pixel targeted for the image processing by the fetched image processing command in an image frame of the digital image signal based on the process delay information added to the fetched image processing command and a counter value indicating the number of pixels obtained by the input unit, and that issues the fetched image processing command when a calculated position is in a valid area, and does not issue the fetched image processing command when the calculated position is not in the valid area; and

a command executing unit that performs the image processing on the pixel targeted for the image processing written in the second buffer by executing the image processing command issued by the command fetching/issuing unit.

### BRIEF DESCRIPTION OF THE DRAWINGS

FIG. 1 is a block diagram of a configuration of an image processing processor according to a first embodiment of the present invention;

FIG. 2 is a schematic diagram for explaining an example of an image frame;

FIG. 3 is a schematic diagram for explaining an example of a format of a command string;

FIG. 4 is a flowchart for explaining an operation in which the image processing processor according to the first embodiment synchronizes input image data and execution of image processing;

FIG. 5 is a flowchart for explaining execution of a command string in the image processing processor according to the first embodiment;

FIG. 6 is a timing chart for explaining a flow of image data in the image processing processor according to the first embodiment;

FIG. 7 is a block diagram of a configuration of an image processing processor according to a second embodiment of the present invention; and

FIG. 8 is a timing chart for explaining a flow of image data in the image processing processor according to the second embodiment.

### DETAILED DESCRIPTION OF THE INVENTION

Exemplary embodiments of an image processing processor, an image processing method, and an imaging apparatus according to the present invention will be explained below in detail with reference to the accompanying drawings. The present invention is not limited to the embodiments.

An image processing processor according to an embodiment of the present invention is mounted on an imaging apparatus, such as a video camera and a digital still camera, that has a digital-image-signal generating unit, such as a CMOS sensor and a charge coupled device (CCD) sensor, that outputs a digital image signal from an optical image of a subject, for example, at a predetermined data rate. To the image processing processor, the digital image signal thus output is sequentially input.

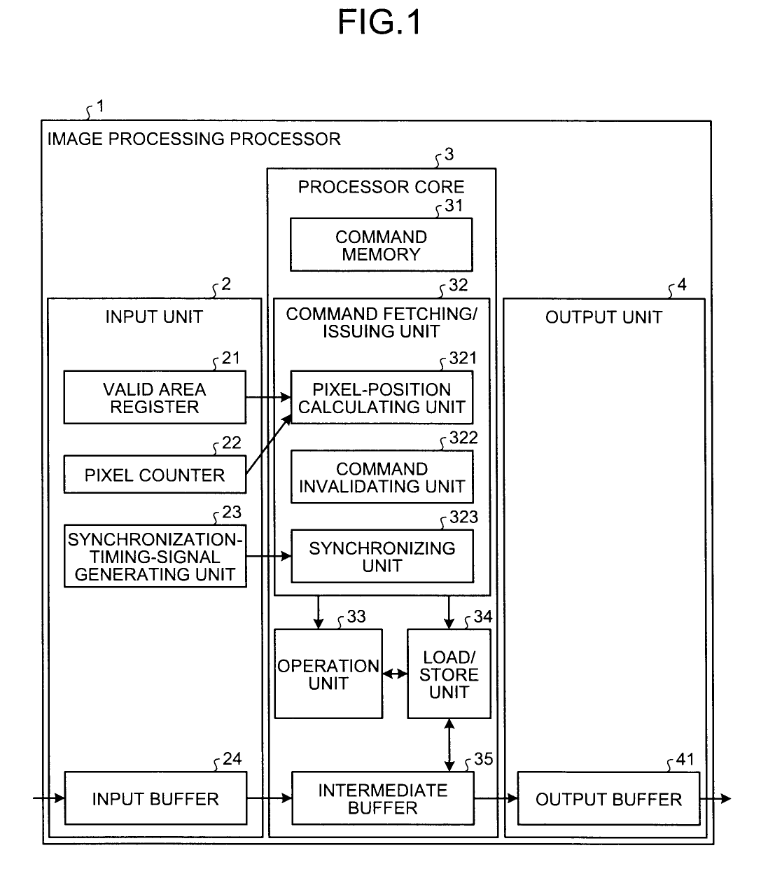

FIG. 1 is a block diagram of a configuration of an image processing processor according to a first embodiment of the present invention. As shown in FIG. 1, an image processing processor 1 according to the first embodiment includes an input unit 2 that receives a digital image signal (hereinafter, simply “image data”) that is input in the raster-scanned order one pixel at one image clock from an external device, a processor core 3 that performs image processing such as lens shading and interpolation on the image data received by the input unit 2, and an output unit 4 that outputs the image data on which the processor core 3 has performed image processing in a raster-scanned order one pixel at one image clock to an external device.

Buffers and a flow of image data are explained. The input unit 2 includes an input buffer 24 that temporarily stores the image data that is input in a raster-scanned order. The processor core 3 includes an intermediate buffer 35 that is used as a work area of image processing. The input unit 2 reads image data from the input buffer 24 and writes in the intermediate buffer 35. The intermediate buffer 35 stores pixel data of a pixel (a target pixel) being a subject of the image processing and adjacent pixels that are used in the image processing to be performed on the target pixel, and intermediate data that is generated as a result of the image processing. The output unit 4 includes an output buffer 41, and reads image data obtained as a result of the image processing from the intermediate buffer 35 and stores in the output buffer 41 temporarily. The image data stored in the output buffer 41 is output to an external device in a raster-scanned order.

The operation of reading image data from the input buffer 24 and writing in the intermediate buffer 35, the image processing performed on the image data written in the intermediate buffer 35, the operation of writing a result of the image processing in the output buffer 41, and the operation of outputting the image data from the output buffer 41 to an external device are performed in synchronization with the input of image data from an external device, at each process-unit pixel amount being the number of pixels of image data that is input in a period from a point of synchronization to a point of next synchronization in a pipeline processing manner. Therefore, the input buffer 24 and the output buffer 41 are configured to have the capacity corresponding to the process-unit pixel amount. For example, the input buffer 24 and the output buffer 41 have the capacity equal to or equivalent to the process-unit pixel amount. To reduce the capacity of the input buffer 24 and the output buffer 41, the cycle of synchronization is set to be short such that the process-unit pixel amount is a minimum value, such as 1 pixel.

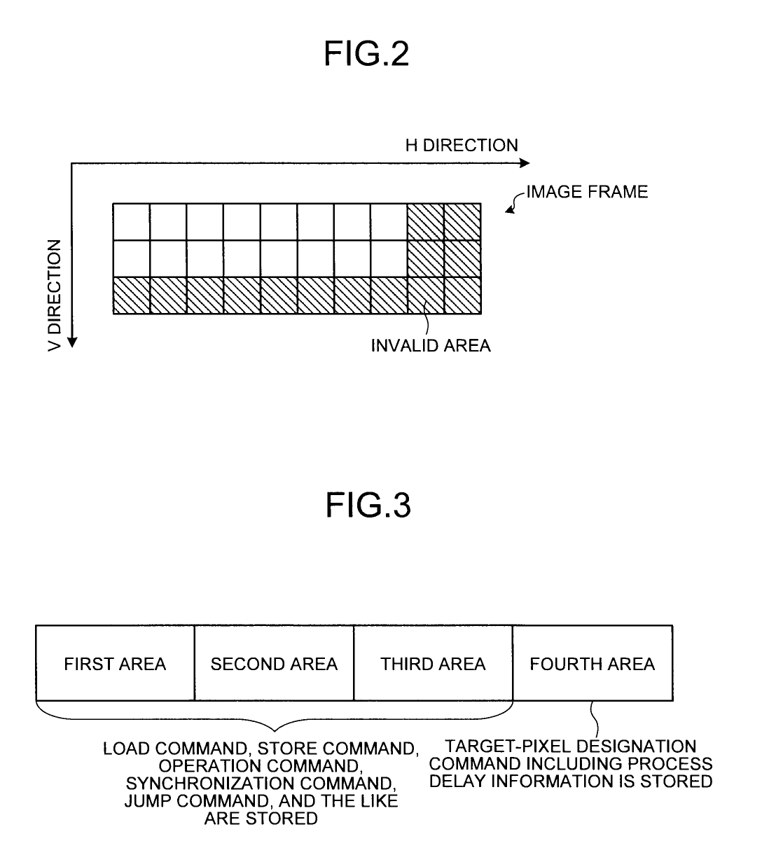

Image data to be input from an external device is explained. Image data input from an external device includes an invalid area such as a blanking period. FIG. 2 is an example of an image frame. As shown in FIG. 2, in an image frame of 10 pixels in H direction×3 pixels in V direction, 2 pixels on right in the first and the second lines and all pixels on the third line correspond to an invalid area. The image processing processor 1 calculates the position of the target pixel for a command each time a command for image processing is fetched (acquired), and determines whether the target pixel is positioned in a valid area (an area not invalid). The image processing processor 1 has a function of canceling execution of the fetched command when the target pixel is positioned in the invalid area.

Referring back to FIG. 1, the input unit 2 includes the input buffer 24, a pixel counter 22 that counts the number of input pixels, a synchronization-timing-signal generating unit 23 that issues a synchronization timing signal each time input image data reaches the process-unit pixel amount, and a valid area register 21 that is used to determine whether a target pixel is positioned in a valid area.

The processor core 3 includes the intermediate buffer 35, a command memory 31 serving as a command storage unit that stores a command (an image processing command) concerning the image processing, an operation unit 33 and a load/store unit 34 serving as a command executing unit that executes a command, and a command fetching/issuing unit 32 serving as a command fetching/issuing unit that fetches a command from the command memory 31 and issues a command to the operation unit 33 and the load/store unit 34. The load/store unit 34 reads and writes image data from and to the intermediate buffer 35.

A format of a command stored in the command memory 31 is explained. A command (hereinafter, “command string”) stored is the command memory 31 has a structure in which a plurality of commands (hereinafter, “small commands”) that can be executed at the same time are included. FIG. 3 is a schematic diagram for explaining one example of the format of a command string that is stored in the command memory 31. As shown in FIG. 3, a single command string has a first area, a second area, and a third area in which small commands are stored, respectively, and a fourth area in which a target-pixel designation command is stored.

The target-pixel designation command has a process delay information that indicates a delay amount required until the operation of a small command in the command string is started on the first pixel since the first pixel of an image frame to which the target pixel belongs is input from an external device, and the position of the target pixel is calculated based on the process delay information and a counter value of the pixel counter 22. When the target pixel is positioned in a valid area, small commands in the command string are executed, and when the target pixel is positioned in an invalid area, the small commands in the command string are not executed. The delay amount indicated by the process delay information is expressed by the number of input pixels that are input in a period from the point of synchronization to a point of another synchronization, or time such as the number of image clocks corresponding to the number of input pixels.

The small commands to be stored in the first area, the second area, and the third area include synchronization command to synchronize input of image data from an external device and image processing performed on the input image data, and a jump command to change the address from which a next command string is fetched, in addition to a load command to read image data from a reading source, a store command to write image data in a writing destination, an operation command to execute image processing, and a command to execute an operation of pixels.

The command fetching/issuing unit 32 fetches a command string and then issues a small command that is included in the command string. That is, the command fetching/issuing unit 32 issues an operation command to the operation unit 33, and issues a load command and a store command to the load/store unit 34. The command fetching/issuing unit 32 executes a synchronization command, a jump command, and a target-pixel designation command by itself.

The command fetching/issuing unit 32 includes a pixel-position calculating unit 321 that calculates the position of a target pixel based on the process delay information included in the target-pixel designation command and the value of the pixel counter 22, to execute the target-pixel designation command, and a command invalidating unit 322 that determines whether the calculated position of the target pixel is in a valid area based on the value of the valid area register 21, and that arranges not to issue small commands included in the command string to the operation unit 33 and the load/store unit 34 when the position of the target pixel is not in a valid area.

Moreover, the command fetching/issuing unit 32 includes a synchronizing unit 323 that executes a synchronization command. When a synchronization command is included in a fetched command string, the synchronizing unit 323 interprets the synchronization command, and executes a control to cause the command fetching/issuing unit 32 to wait to execute the operation of fetching a command string until a next synchronization timing signal is issued by the synchronization-timing-signal generating unit 23. The synchronizing unit 323 cancels the standby of the operation of fetching a command when a next synchronization timing signal is issued, and causes the command fetching/issuing unit 32 to fetch a next command string.

When a jump command is executed, the command fetching/issuing unit 32 reads a next command string from a reading source in the command memory 31 that is designated by the jump command.

The output unit 4 includes the output buffer 41 as described above.

Next, the operation of the image processing processor 1 according to the first embodiment configured as described above is explained. In the following explanations of the operation, it is assumed that the image frame shown in FIG. 2 is input, the synchronization-timing-signal generating unit 23 issues a synchronization timing signal each time 1 pixel is input, and the counter value of the pixel counter 22 is reset to indicate 1 when the first pixel of the image frame is input.

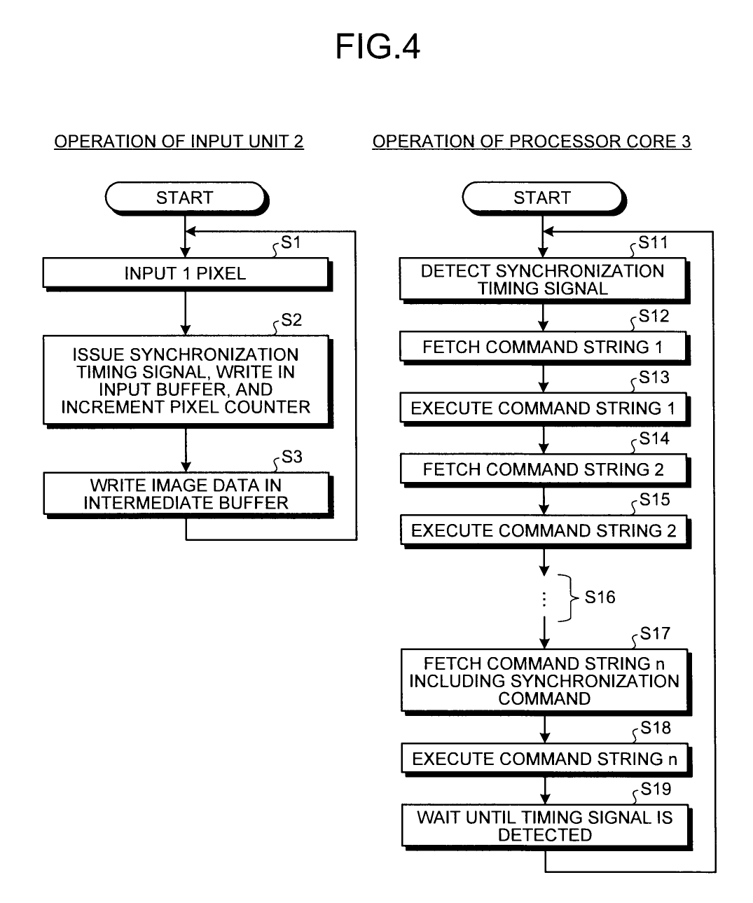

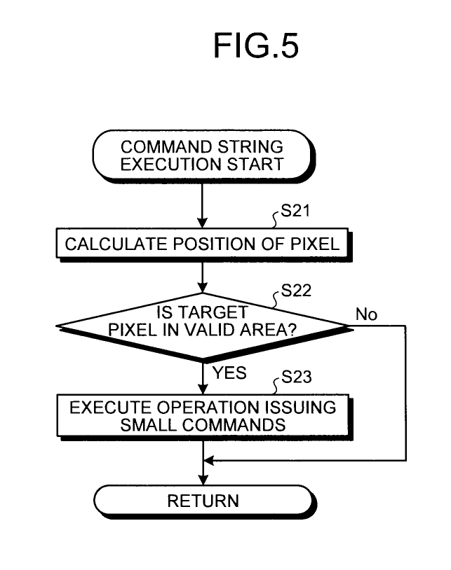

FIG. 4 is a flowchart for explaining the operation in which the image processing processor 1 synchronizes input image data and execution of image processing. A flowchart on the left shown in FIG. 4 is for explaining the operation of the input unit 2. As shown in FIG. 4, when 1 pixel is input (Step S1), the input unit 2 issues a synchronization timing signal, writes the input 1 pixel in the input buffer 24, and increments the pixel counter 22 (Step S2). The input unit 2 then writes, in the intermediate buffer 35, the 1 pixel input to the input buffer 24 (Step S3). The process then proceeds to Step S1.

The processor core 3 performs the operation of performing various kinds of image processing on the 1 pixel of the target pixel written in the intermediate buffer 35 based on command strings 1 to n-1 in which no synchronization command is included and a command string n in which the synchronization command is included during the period from the synchronization timing signal is detected until a next synchronization timing signal is detected in pipeline. A flowchart shown on the right in FIG. 4 explains the operation of the processor core 3.

As shown in the flowchart on the right in FIG. 4, in the processor core 3, when the synchronizing unit 323 detects issuance of a synchronization timing signal (Step S11), the command fetching/issuing unit 32 fetches the command string 1 (Step S12), and the command string 1 is executed on the 1 pixel being the target pixel of the command string 1 (Step S13). The fetching and execution of the fetched command string are repeated until the command string n-1 is reached (Step S14 to S16). Subsequently, the command fetching/issuing unit 32 fetches the command string n in which a synchronization command is included (Step S17), and when the command string n is executed (Step S18), the synchronizing unit 323 that has interpreted the synchronization command brings the command fetching/issuing unit 32 into a standby state in which the fetching of a new command string is waited until issuance of a next synchronization timing signal is detected (Step S19). Thereafter, when the synchronizing unit 323 detects issuance of a synchronization timing signal (Step S11), the operation from Step S12 to Step S19 is performed on a next pixel. The processor core 3 performs the operation from Step S11 to Step S19 in pipeline, and therefore a target pixel of each operation based on the command strings 1 to n is not necessarily the identical pixel.

As described above, the image data input to the input unit 2 and the image processing on the image data by the processor core 3 are synchronized. As another synchronization method, a polling method in which a register that indicates that accumulated image data has reached the process-unit pixel amount in the input unit 2 and the output unit 4 is provided and the processor core 3 reads the register at certain time intervals to achieve the synchronization, and an interrupt method in which the input unit 2 notifies that accumulated image data has reached the process-unit pixel amount by a hardware signal and a receiver thereof is connected to an interrupt controller of the processor core 3 can be applied. However, the synchronization method according to the first embodiment has less overhead than these synchronization methods, and therefore synchronization can be achieved in a higher speed. That is, compared to the polling method and the interrupt method, it is possible to set the cycle of synchronization short while keeping the amount of increase of overhead low.

FIG. 5 is a flowchart for explaining the execution (Steps S13, S15, . . . , Step S18) of fetched commands in further detail.

A shown in FIG. 5, upon fetching a command string, in the command fetching/issuing unit 32, the pixel-position calculating unit 321 calculates the position of a pixel that is targeted for the operation of a small command included in the command string based on the counter value of the pixel counter 22 and the process delay information included in the target-pixel designation command (Step S21). One example of calculation of a pixel position is explained below.

When the position of a pixel targeted for the operation in the image frame shown in FIG. 2 is X-th pixel on Y-th line, the delay amount indicated by the process delay information is D pixels, and the current counter value is C,

C−D=(X−1)+(Y−1)×10 (Equation 1)

(where X and Y are positive integers satisfying 1≦X≦10, 1≦Y≦3) is satisfied. Therefore, X and Y can be calculated from the counter value C and the delay amount D. For example, when the current counter value of the pixel counter 22 is 14, and the delay amount is D pixels, it is calculated as (X, Y)=(3, 1). That is, the position of the target pixel is the third pixel on the first line.

Following Step S21, the command invalidating unit 322 determines whether the position of the pixel is in a valid area referring to the valid area register 21 (Step S22). Although the form of expression of the valid area by the valid area register 21 is not particularly limited, because the valid area in the image frame shown in FIG. 2 is an area of 1≦X≦8 and 1≦Y≦2, for example, it can be expressed as 1, 8, 1, 2 indicating minimum values and maximum values in the valid area in X and Y using four registers.

When the position of the pixel is in the valid area (YES at Step S22), the command fetching/issuing unit 32 issues small commands stored in the first to the third areas (Step S23). When the position of the pixel is not in the valid area (NO at Step S22), the command invalidating unit 322 invalidates the small commands included in the command string, and the execution of the command string is ended without issuing the small commands by the command fetching/issuing unit 32. However, even when the pixel targeted by the command string n is positioned in the invalid area, to wait until next synchronization timing signal, only a synchronization command is issued to the synchronizing unit 323 as an exemption, even when the position of the pixel is not in the valid area.

As described above, the command fetching/issuing unit 32 calculates the position of a pixel targeted by a small command included in a command string based on the process delay information indicating the delay amount in the fetched command string and the counter value. Therefore, the intermediate buffer 35 is freed from such a constraint that a large amount of data in a line unit or a frame unit is required as in the technique disclosed in Japanese Patent Application Laid-Open No. 2003-29979, and the capacity of the intermediate buffer 35 can be reduced. For example, when an operation of image processing is to be performed on a pixel in center using 3 pixels in H direction×3 pixels in V direction, in the technique disclosed in Japanese Patent Application Laid-Open No. 2003-29979, the capacity for at least three lines is required just for an area to store the image data of a target pixel before subjected to the image processing and adjacent pixels used in the operation of the image processing for the target pixel, even though the process-unit pixel amount corresponds to the size smaller than one line. To the contrary, in the image processing processor 1, the capacity can be reduced to the size corresponding to 2 lines+3 pixels if the process-unit pixel amount is set to 1 pixel.

When the calculated position of the pixel is in the invalid area, the operation that the small commands included in the command string are not issued is executed. Therefore, the intermediate buffer 35 does not require the capacity to store intermediate data of the image processing for the pixel in the invalid area. Accordingly, in the intermediate buffer 25, the capacity to store the intermediate data of the invalid area can be further reduced.

If the operation of calculating the position of a target pixel and the operation of determining whether the calculated position is in the valid area are executed by software, several conditional branches are required, and overhead originated in such conditional branches increases. However, because the image processing processor 1 performs these operations by hardware, the operations can be performed in a high speed compared to the case of software.

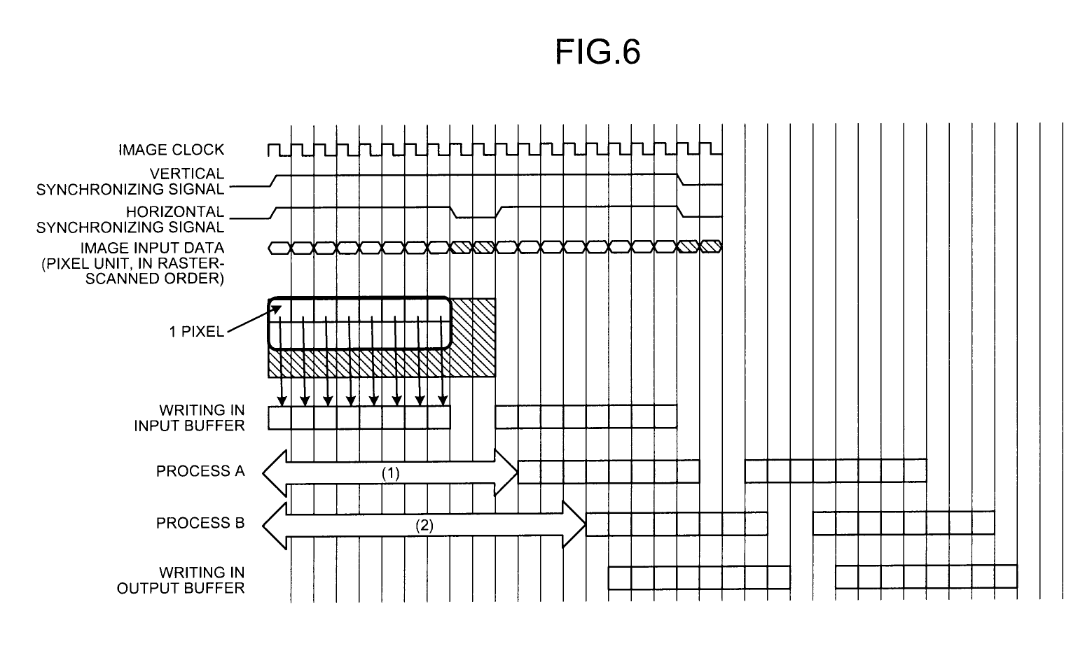

FIG. 6 is a timing chart for explaining a specific example of a flow of image data. In FIG. 6, the first line indicates an image clock, the second line indicates a vertical synchronizing signal that is asserted at the head of a frame and de-asserted at the end of the frame, the third line indicates a horizontal synchronizing signal that is asserted for the image in the valid area in H direction and de-asserted at the end of pixels in the valid area, and the fourth line indicates an input pixel. Lines stretched from the top line through the bottom line indicate the synchronization timing signals. The input unit 2 is configured not to write pixels in the invalid area in the input buffer 24 based on the horizontal synchronizing signal.

The input unit 2 sequentially writes image data that is input to the input unit 2 as shown in the first line to the fourth line in the input buffer 24 as shown in the fifth line. The input unit 2 then sequentially writes the written image data into the intermediate buffer 25 one pixel each. The processor core 3 performs a process A shown on the sixth line and a process B shown on the seventh line based on the command strings 1 to n. The output unit 4 reads the image data subjected to the process B one pixel each and writes in the output buffer 41 as shown in the eighth line.

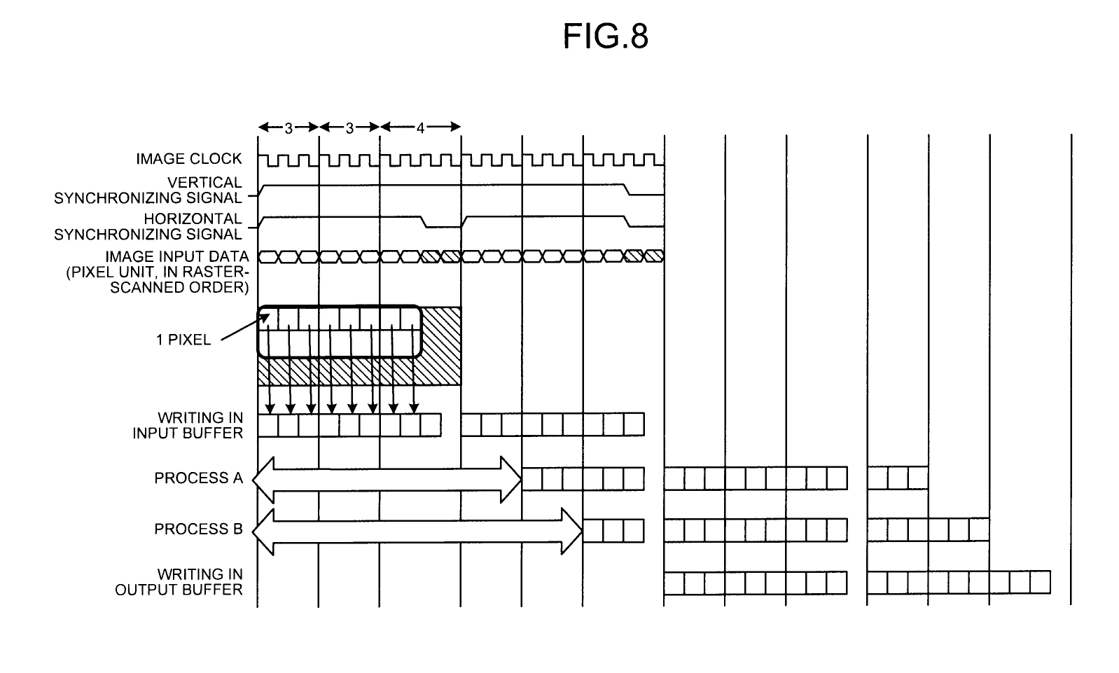

The command string for the operation of the process A includes the target-pixel designation command that includes the process delay information specifying the delay amount of 11 pixels as shown by an arrow (1) in FIG. 8. When the command string for the process A is executed when the counter value is 11, the target pixel of the command string is determined as the top pixel of an image frame from the equation (1). For the processing A, when the counter value is 19, 20, 29, or 30, the target pixel is determined to be positioned in the invalid area from the equation (1) and the valid area register 21, and the small commands are not executed and reading and writing of the intermediate data are not executed. Similarly, the command string for the operation of the process B includes the target-pixel designation command that includes the process delay information specifying the delay amount of 14 pixels as shown by an arrow (2) in FIG. 8. When the command string for the process B is executed when the counter value is 14, the target pixel of the command string is determined as the top pixel of the image frame. Also for the process B, when the counter value is 22, 23, 32, or 33, reading and writing of the intermediate data are not executed. As described above, because reading and writing of the intermediate data of a pixel in the invalid area are not executed, in the intermediate buffer 35, the area to store the intermediate data of pixel data in the invalid area can be omitted.

As described above, according to the first embodiment, the image processing processor is configured such that a command including information indicating a delay amount required until image processing is executed since the input of a digital image signal is fetched, the position of a pixel is calculated based on the delay amount and a counter value of pixels input from an external device, and the fetched command is executed when the position of the pixel is in the valid area while the fetched command is not executed when the position of the pixel is in the invalid area. Therefore, if the synchronization cycle is set to be short, the capacity of the input buffer, the intermediate buffer, and the output buffer can be reduced. Thus, an image processing processor in which the capacity of buffers is minimized can be provided.

Although in the above explanations, the input unit 2, the processor core 3, and the output unit 4 have the input buffer 24, the intermediate buffer 35, and the output buffer 41, respectively, positions at which each buffer is provided is not limited thereto.

Moreover, although the pixel counter 22 is explained that the counter value is reset to indicate “1” when the first pixel of an image frame is input, as an example, it can be configured to be reset in any way, as long as a position of a pixel and a counter value is associated so that the position of a pixel can be calculated from the relation between the counter value and the delay amount. For example, the pixel counter 22 can be configured as a two-dimensional counter constituted by two kinds of counters for H direction and V direction such that the counter value of H direction is incremented each time 1 pixel is input, and the counter value of V direction is incremented each time pixels of one line are input. Similarly, the delay amount can also be expressed by two kinds of amounts in H direction and V direction.

Furthermore, although the expression of the delay amount in the process delay information is not specifically described, the delay amount can be expressed directly by a value indicating the delay amount, or indirectly by indicating a register in which a value of the delay amount is stored.

Moreover, although the method of setting a value indicated by the valid area register 21 is not specifically mentioned, it can be configured to be set at the initial setting, or a function of automatically setting the value based on the horizontal synchronizing signal and the vertical synchronizing signal can be added to the input unit 2, for example. If it is configured to add the function of automatically setting the value, a process of the initial setting of the valid area register 21 can be omitted.

Furthermore, a jump command function can be added to the synchronization command. By such an arrangement, a jump command is not required to be included in a command string in addition to the synchronization command. When the jump command function is added to the synchronization command, it can be arranged to jump to a predetermined address, or to specify an address of a jump destination by specifying an immediate value or a register.

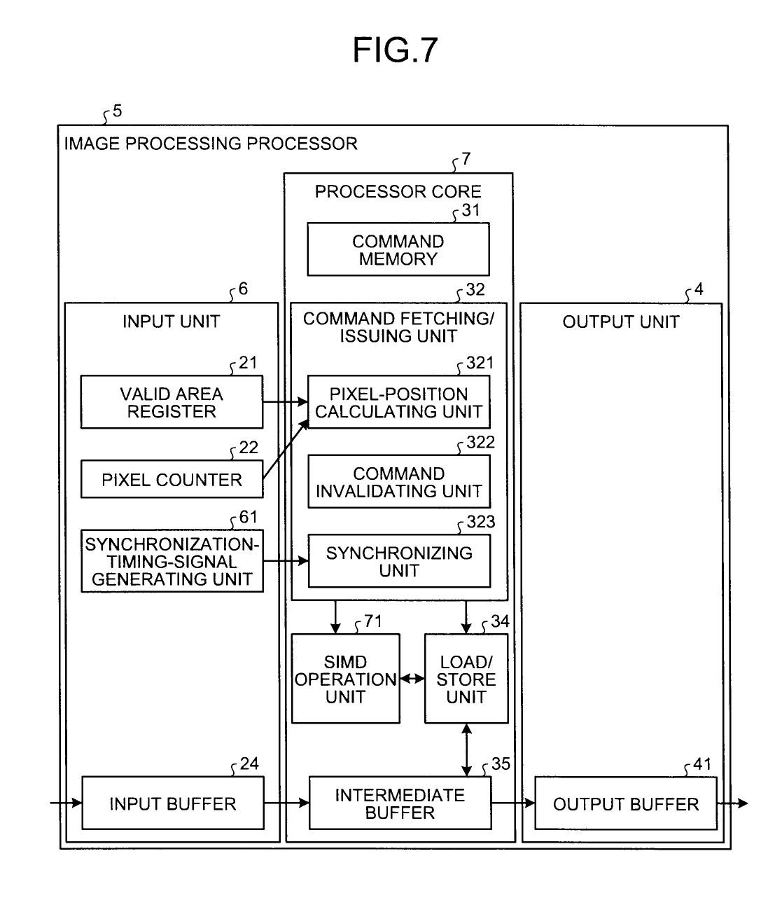

An image processing processor according to a second embodiment of the present invention is explained next. FIG. 7 is a block diagram of a configuration of an image processing processor 5 according to the second embodiment. For respective components of the image processing processor 5 shown in FIG. 7, like reference numerals refer to the same functions as the first embodiment, and explanations thereof will be omitted.

As shown in FIG. 7, the image processing processor 5 includes an input unit 6 that receives image data input in the raster-scanned order one pixel at one image clock from an external device, a processor core 7 that performs image processing on the image data received by the input unit 6, and the output unit 4 that outputs the image data on which the processor core 7 has performed image processing in a raster-scanned order one pixel at one image clock to an external device.

The processor core 7 performs image processing on data of single instruction multiple data (SIMD). Specifically, the processor core 7 includes a SIMD operation unit 71 that performs the same operation on a plurality of pixels at the same time by a single operation command, in place of the operation unit 33. The process-unit pixel amount is set to the number of pixels for which the SIMD operation unit 71 can perform an operation, that is a SIMD width.

The input unit 6 includes a synchronization-timing-signal generating unit 61 in place of the synchronization-timing-signal generating unit 23. The synchronization-timing-signal generating unit 61 issues a synchronization timing signal each time the image data corresponding to the process-unit pixel amount, that is the SIMD width, is input. When the number of horizontal pixels is not an integral multiple of the SIMD width, the synchronization-timing-signal generating unit 61 partially adjusts an interval of issuing the synchronization timing signal to bring a synchronization point to the head of a following line so that image data of different lines are not included in the same SIMD data.

A flow of image data in the image processing processor 5 configured as described above is explained next. FIG. 8 is a timing chart for explaining a flow of image data. In FIG. 8, it is assumed that the image frame shown in FIG. 8 is input, and the SIMD width is 3 pixels.

As shown in FIG. 8, when pixel data of one line is sequentially written in the input buffer 24, the synchronization timing signal is issued for each three image clocks corresponding to the SIMD width, and the final synchronization timing signal of one line is issued when 4 pixels are input since last issuance of the synchronization timing signal. Thus, pixels of different lines are prevented from being mixed in SIMD data, that is data of the process-unit pixel amount.

As described above, according to the second embodiment, the same operation can be performed on pixels of the process-unit pixel amount. Therefore, as compared to the first embodiment, the operation of the command fetching/issuing unit is facilitated.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An image processing processor that sequentially performs image processing on a digital image signal that is input at a fixed data rate, in synchronization with input of the digital image signal, the image processing processor comprising:
an input unit that sequentially writes a digital image signal to be input in a first buffer while counting number of pixels of the digital image signal, and that reads the digital image signal written in the first buffer to write in a second buffer;
a command storage unit that stores an image processing command to which process delay information is added, the process delay information indicating a delay amount required until image processing is started by the image processing command since input of the digital image signal to the input unit;
a command fetching/issuing unit that fetches the image processing command from the command storage unit, that calculates a position of a pixel targeted for the image processing by the fetched image processing command in an image frame of a digital image signal based on the process delay information added to the fetched image processing command and a counter value indicating the number of pixels obtained by the input unit, and that issues the fetched image processing command when a calculated position is in a valid area, and does not issue the fetched image processing command when the calculated position is not in the valid area; and
a command executing unit that performs image processing on the pixel targeted for the image processing written in the second buffer by executing the image processing command issued by the command fetching/issuing unit.

2. The image processing processor according to claim 1, wherein
the input unit includes a synchronization-timing-signal issuing unit that issues a synchronization timing signal each time a predetermined number of pixels are input, and reads a predetermined number of pixels from the first buffer to write in the second buffer each time the synchronization timing signal is issued, and
the command fetching/issuing unit completes image processing on a predetermined number of pixels written in the second buffer within a period from when the synchronization timing signal is issued until a next synchronization timing signal is issued, and waits until the next synchronization timing signal is issued to fetch a next image processing command.

3. The image processing processor according to claim 1, further comprising a valid area register that indicates a valid area in the image frame in the digital image signal to be input, wherein
the command fetching/issuing unit determines whether the calculated position is in the valid area by referring to the valid area register.

4. The image processing processor according to claim 2, wherein to the image processing command, a synchronization command is added, the synchronization command causing the command fetching/issuing unit to wait until a next synchronization timing signal is issued, to fetch an image processing command.

5. The image processing processor according to claim 4, wherein the synchronization command functions as a jump command.

6. The image processing processor according to claim 1, further comprising an output unit that sequentially stores pixels on which the image processing has been performed by the command executing unit in a third buffer being an output buffer.

7. The image processing processor according to claim 2, wherein the command executing unit is configured to be capable of performing identical image processing on a predetermined number of pixels at a same time.

8. The image processing processor according to claim 2, wherein the synchronization-timing-signal issuing unit adjusts intervals of issuing the synchronization timing signal such that the synchronization timing signal is issued at a timing when a head of each line of the digital image signal is input.

9. The image processing processor according to claim 1, wherein the process delay information indicates a delay amount directly or indirectly using a register.

10. An image processing method of sequentially performing image processing on a digital image signal that is input at a fixed data rate, in synchronization with input of the digital image signal, the image processing method comprising:
writing a digital image signal to be input sequentially in a first buffer while counting number of pixels of the digital image signal, and reading the digital image signal written in the first buffer to write in a second buffer;
fetching an image processing command to which process delay information is added from a command storage unit, the process delay information indicating a delay amount required until image processing is started by the image processing command since input of the digital image signal;
calculating a position of a pixel targeted for the image processing by the fetched image processing command in an image frame of a digital image signal based on the process delay information added to the fetched image processing command and a counter value indicating the number of pixels;
issuing the fetched image processing command when a calculated position is in a valid area, and arranging not to issue the fetched image processing command when the calculated position is not in the valid area; and
performing the image processing on the pixel targeted for the image processing written in the second buffer by executing the issued image processing command.

11. The image processing method according to claim 10, further comprising issuing a synchronization timing signal each time a predetermined number of pixels are input, wherein
a predetermined number of pixels are read from the first buffer to write in the second buffer each time the synchronization timing signal is issued, and
the image processing is on a predetermined number of pixels written in the second buffer is completed within a period from when the synchronization timing signal is issued until a next synchronization timing signal is issued, and fetching of a next image processing command is waited until the next synchronization timing signal is issued.

12. The image processing method according to claim 10, wherein whether the calculated position is in the valid area is determined by referring to the valid area register.

13. The image processing method according to claim 11, wherein to the image processing command, a synchronization command is added by which fetching of an image processing command is waited until a next synchronization timing signal is issued.

14. The image processing method according to claim 13, wherein the synchronization command functions as a jump command.

15. The image processing method according to claim 10, further comprising storing pixels on which the image processing has been performed by the command executing unit sequentially in a third buffer being an output buffer.

16. The image processing method according to claim 11, wherein identical image processing is performed on a predetermined number of pixels at a same time.

17. The image processing method according to claim 11, wherein intervals of issuing the synchronization timing signal is adjusted such that the synchronization timing signal is issued at a timing when a head of each line of the digital image signal is input.

18. The image processing method according to claim 10, wherein the process delay information indicates a delay amount directly or indirectly using a register.

19. An imaging apparatus comprising:
a digital-image-signal generating unit that outputs a digital image signal at a fixed data rate from an optical image of a subject; and
an image processing processor to which a digital image signal generated by the digital-image-signal generating unit is sequentially input, and that sequentially performs image processing on the digital image signal, in synchronization with the input, wherein
the image processing processor comprises:
an input unit that sequentially writes a digital image signal to be input in a first buffer while counting number of pixels of the digital image signal, and that reads the digital image signal written in the first buffer to write in a second buffer;
a command storage unit that stores an image processing command to which process delay information is added, the process delay information indicating a delay amount required until image processing is started by the image processing command since input of the digital image signal to the input unit;
a command fetching/issuing unit that fetches the image processing command from the command storage unit, that calculates a position of a pixel targeted for the image processing by the fetched image processing command in an image frame of the digital image signal based on the process delay information added to the fetched image processing command and a counter value indicating the number of pixels obtained by the input unit, and that issues the fetched image processing command when a calculated position is in a valid area, and does not issue the fetched image processing command when the calculated position is not in the valid area; and
a command executing unit that performs the image processing on the pixel targeted for the image processing written in the second buffer by executing the image processing command issued by the command fetching/issuing unit.

20. The imaging apparatus according to claim 19, wherein
the input unit includes a synchronization-timing-signal issuing unit that issues a synchronization timing signal each time a predetermined number of pixels are input, and reads a predetermined number of pixels from the first buffer to write in the second buffer each time the synchronization timing signal is issued, and
the command fetching/issuing unit completes the image processing on a predetermined number of pixels written in the second buffer within a period from when the synchronization timing signal is issued until a next synchronization timing signal is issued, and waits until the next synchronization timing signal is issued to fetch a next image processing command.
